(19) United States
(12) Patent Application Publication
(10) Pub. No.: US 2008/0048360 A1
(43) Pub. Date: Feb. 28, 2008

(54) Method for forming a front shell of a mobile communication device

(75) Inventor: Szu-Wei Wang, Taipei (TW)

Correspondence Address: BRUCE H. TROXELL, SUITE 1404, 5205 LEESBURG PIKE, FALLS CHURCH, VA, 22041, US

(73) Assignee: ARIMA COMMUNICATIONS CORP.

(21) Appl. No.: 11/508,878

(22) Filed: Aug. 24, 2006

(51) Int. Cl. B29C 45/14

(52) U.S. Cl. 264/259

(57) ABSTRACT

A method for integrally forming a front shell of a mobile communication device. The method comprises the steps of: providing a first film with a pattern; putting the first film into a first female part; injecting a plastic material between a first male part and the first female part to form a compact bonding with the first film, thereby to form a first window lens; rotatably interchanging the first and second male parts therebetween to pair the first male part and the second female part and to pair the second male part and the first female part, thereby to move the first window lens with the first male part; manually or mechanically providing a second film in the first female part; simultaneously injecting the plastic material into each molding assembly, thereby to form the front shell by the molded plastic material between the first male part and the second female part and to form a second window lens between the second male part and the first female part; and removing the front shell.

### BACKGROUND OF THE INVENTION

1. Field of the Invention

The invention relates to a method for integrally forming a front shell of a mobile communication device, and in particular to a process for forming the front shell of the mobile communication device by In-Mold Film (IMF) and double injection molding.

2. Description of the Related Art

In general, a conventional mobile communication device such as a cellular phone comprises an outer shell and a front shell having a window lens formed by In-Mold Film (IMF). The window lens is formed by a film having a pattern printed on a surface thereof via an ink-printing method. After high-pressure formation process, the processed film with the pattern is cut into pieces with desired shapes. The selected film manually or mechanically placed in an injection mold is integrally molded by the injected plastic material to form the front shell.

Further, the outer shell can be manufactured by single or double injection molding technology. With a single material pipe and one set of mold of single-material molding injection machine, single injection molding combines one plastic material injected into the mold to form a single part with one material. Thus, the product can be removed from the mold after the single-injection formation process. Further, with a double material pipe and two sets of molds of double-material molding injection machine, double injection molding combines two plastic materials injected into the molds to form a single part with two visible colors and two materials under two sequential formation processes, i.e., two different materials can be integrally formed.

In FIG. 1, in the process of double injection molding to form an outer shell 24 of a conventional mobile phone (not shown), a first mold 10 and a second mold 20 are provided and capable of performing opening, clamping and rotatably interchanging therebetween. The first mold 10 comprises a first male part 11 and a first female part 12, and the second mold 20 comprises a second male part 21 having the same structure as the first male part 11 of the first mold 10 and a second female part 22 having a shape different from that of the first female part 12 of the first mold 10. An inner cavity 13 can be formed between the first male part 11 and the first female part 12. Due to two different plastic materials being applied, the first and second molds 10 and 20 of double injection molding are provided with two different sprue gates for injection. Further, on one side of the first and second male parts 11 and 21, a submarine gate is provided for injection. If a sliding block is further provided in the first and second molds 10 and 20, the sliding block can be engaged to one side of the first and second female parts 12 and 22.

The method for forming the outer shell 24 comprises the steps of: (a) providing the first mold 10 with the first male part 11 and the first female part 12 and the second mold 20 with the second male part 21 and the second female part 22, wherein the first/second male parts 11/21 and the first/second female parts 12/22 are capable of being overlapped, respectively; (b) closing the first and second molds 10 and 20 to be in a mold clamping status, thereby to inject the plastic material into the inner cavity 13 formed between the first male part 11 and the first female part 12 to form a partial compact 14; (c) opening the first and second molds 10 and 20 to be in a mold opening status and rotating the first and second male parts 11 and 21 with respect to the fixed first and second female parts 12 and 22 to pair the first male part 11 and the second female part 22 and to pair the second male part 21 and the first female part 12, thereby to move the partial compact 14 with the first male part 11; (d) closing the first and second molds 10 and 20 to be in a mold clamping status and injecting plastic material into the inner cavities 13 and 23, thereby to form the outer shell 24 with two materials or two visible colors in the first male part 11 and the second female part 22 and to form a partial compact 15 in the second male part 21 and the first female part 12; and (e) opening the first and second molds 10 and 20 to remove the outer shell 24.

In FIG. 2, a window lens 30 and the outer shell 24 are integrally formed by a glue bar 31. Part of the outer shell 24 must be set as a region for attaching the window lens 30, however, the thickness of the assembled structure cannot be decreased. Further, two injecting machines, two sets of molds (the first and second molds 10 and 20) and self-adhesive zones are required for the connection of the window lens 30 and the outer shell 24, thus cost and assembly time increase.

### BRIEF SUMMARY OF THE INVENTION

The invention provides a method for integrally forming a front shell of a mobile communication device by In-Mold Film (IMF) and double injection molding, thus to eliminate self-adhesive zones.

To achieve the described purpose, the method for the invention comprises the steps of: providing a first film with a pattern; putting the first film into a first female part; injecting a plastic material between a first male part and the first female part to form a compact bonding with the first film, thereby to form a first window lens; rotatably interchanging the first and second male parts therebetween to pair the first male part and the second female part and to pair the second male part and the first female part, thereby to move the first window lens with the first male part; manually or mechanically providing a second film in the first female part; simultaneously injecting the plastic material into each molding assembly, thereby to form the front shell by the molded plastic material between the first male part and the second female part and to form a second window lens between the second male part and the first female part; and removing the front shell.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of the process of double injection molding to form an outer shell of a conventional mobile phone;

FIG. 2 is a schematically sectional view of a front shell of the conventional mobile phone;

FIG. 3 is a schematic view of the process of a method for forming a front shell of a mobile communication device of the invention;

FIG. 4A is a front view of a first window lens (47) of the mobile communication device of the invention;

FIG. 4B is a front view of an outer shell (49) of the mobile communication device of the invention;

FIG. 4C is a front view of a front shell (54) of the mobile communication device of the invention; and

FIG. 5 is a section view of the front shell (54) along line (5-5) in FIG. 4C.

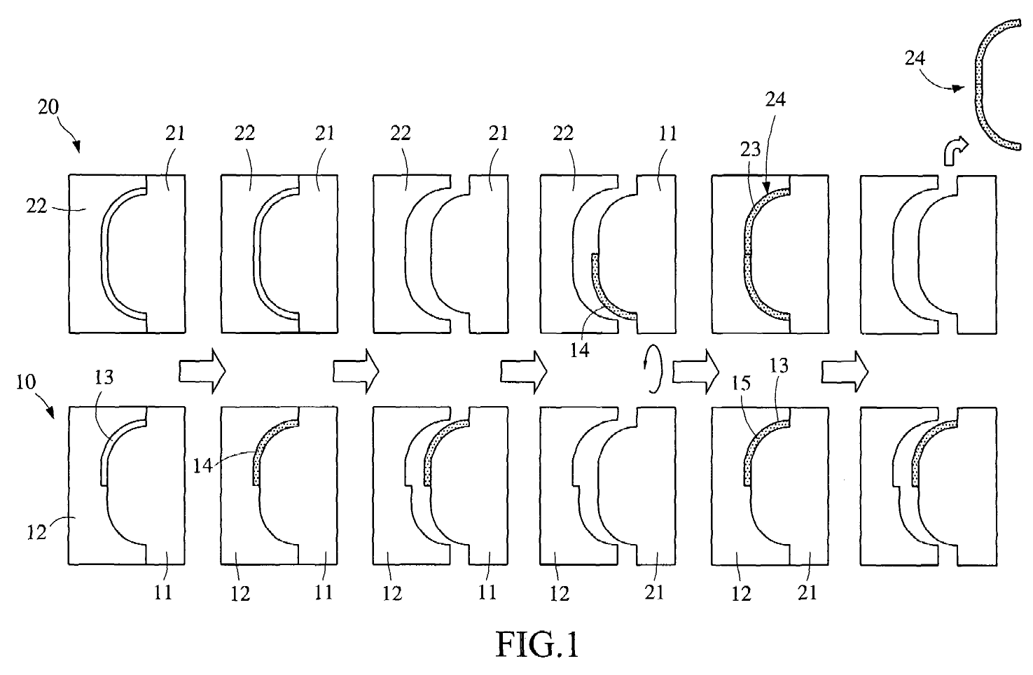

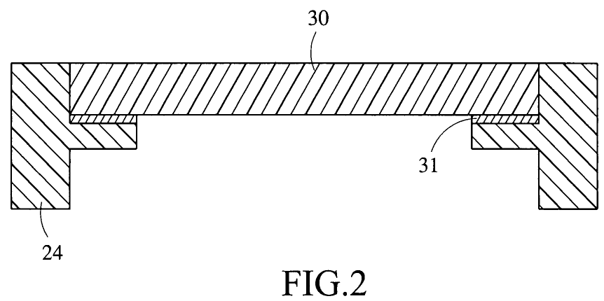

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

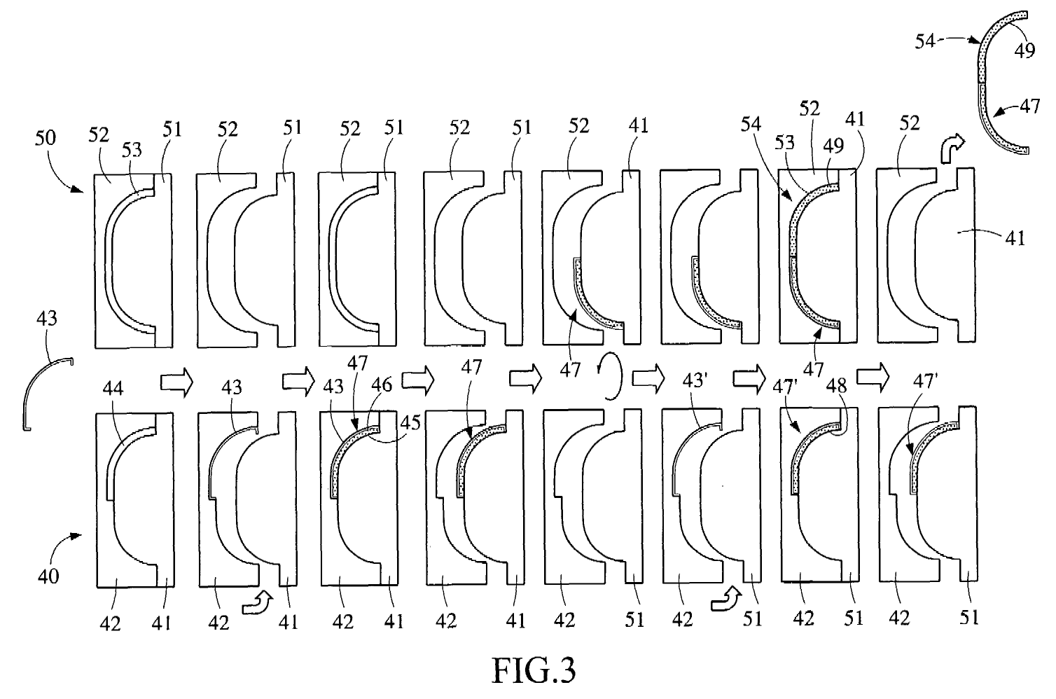

In FIG. 3, the invention provides a method for forming a front shell 54 of a mobile communication device by injecting a plastic material into a set of a first molding assembly 40 and a second molding assembly 50 via an injecting machine. To specify the method for the invention, the mobile communication device, the plastic material and the injecting machine are not shown in figures.

The first molding assembly 40 comprises a first male part 41 and a fixed first female part 42 having a first inner cavity 44. The second molding assembly 50 comprises a second male part 51 and a fixed second female part 52 having a second inner cavity 53. The second male part 51 of the second molding assembly 50 has same shape with the first male part 41 of the first molding assembly 40, and the second male part 51 and the first male part 41 are rotatably interchanged therebetween. The fixed second female part 52 of the second molding assembly 50 has a shape different from that of the first female part 42 of the first molding assembly 40.

The method for forming the front shell 54 comprises the following steps.

First, a first film 43 with a pattern (not shown in Figs.) is provided. The pattern is printed on a surface of the first film 43 via an ink-printing method. Second, the first and second molding assemblies 40 and 50 are in an open mode and the first film 43 is manually or mechanically disposed in the first inner cavity 44 of the fixed first female part 42.

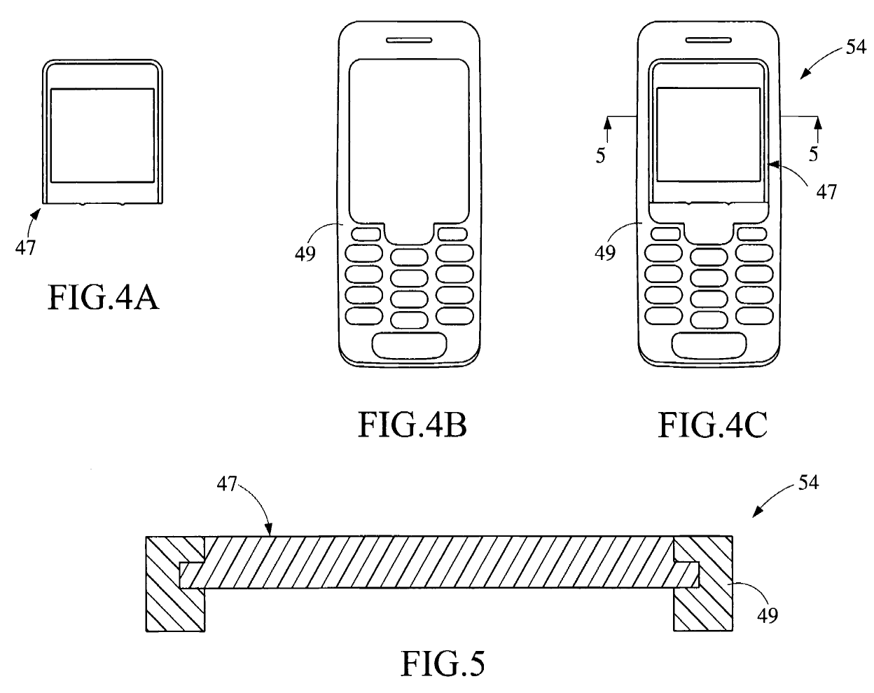

Third, the first and second molding assemblies 40 and 50 are in a closed mode. The plastic material, e.g. PMMA (Poly Methyl Methaclylate) having plastic formation temperature at 190-250° C., PC (Polycarbonate) having plastic formation temperature at 230-270° C. or PET (Poly hylene terphthalate) having a plastic formation temperature at 250-275° C., is injected into a third cavity 45 formed between the first male part 41 and the first film 43 located in the fixed first female part 42. The injected plastic material between the first male part 41 and the first female part 42 to form a compact 46 bonding with the first film 43, thus to form a first window lens 47 (shown in FIG. 4).

Fourth, the first and second molding assemblies 40 and 50 are open to rotatably interchange the first and second male parts 41 and 51 therebetween, to pair the first male part 41 and the second female part 52 and to pair the second male part 51 and the first female part 42. Thus, the first window lens 47 is moved with the first male part 41.

Fifth, a second film 43′ is manually or mechanically provided in the first inner cavity 44 of the first female part 42.

Sixth, the plastic material is simultaneously injected into the first and second male parts 41 and 51, i.e., the second inner cavity 53 of the second female part 52 and a fourth cavity 48 formed between the second male part 51 and the second film 43′ located in the fixed first female part 42 to form an outer shell 49 (shown in FIG. 4B) and the front shell 54 (shown in FIG. 4C) formed by the outer shell 49 and the second window lens 47′, and a second window lens 47′ is formed between the second male part 51 and the first female part 42.

Finally, the first and second molding assemblies 40 and 50 are open to remove the front shell 54.

In FIG. 5, by In-Mold Film (IMF) and double injection molding, the outer shell 49 and the first window lens 47 are integrally formed into the front shell 54.

Thus, based on the described method for forming the front shell 54, the thickness of the mobile communication device is reduced by eliminating self-adhesive zones; the assembling process is simplified by eliminating the process of self-adhesive zones by double-assembly manually and assembling hour and labor can be reduced; the structure of the mobile communication device is strengthened by the front shell integrally formed by the outer shell and the first window lens; total cost can be reduced by using a single double injection molding machine; the yield can be increased.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for forming a front shell (54) of a mobile communication device, wherein the front shell (54) is molded by injecting a plastic material into molding assemblies (40 and 50) via an injecting machine, wherein the molding assemblies (40 and 50) comprises a first male part (41), a second male part (51) having same shape with the first male part (41) and rotatably interchanged with the first male part (41), a fixed first female part (42), and a fixed second female part (52) having a shape different from that of the first female part (42), the method comprising the steps of:
(a) providing a first film (43) with a pattern;
(b) putting the first film (43) into the first female part (42);
(c) injecting the plastic material between the first male part (41) and the first female part (42) to form a compact (46) bonding with the film (43), thereby to form a first window lens (47);
(d) rotatably interchanging the first and second male parts (41 and 51) therebetween to pair the first male part (41) and the second female part (52) and to pair the second male part (51) and the first female part (42), thereby to move the first window lens (47) with the first male part (41);
(e) manually or mechanically providing a second film (43′) in the first female part (42);
(f) simultaneously injecting the plastic material into each molding assembly (40 and 50), thereby to form the front shell (54) by the molded plastic material between the first male part (41) and the second female part (52) and to form a second window lens (47′) between the second male part (51) and the first female part (42); and
(g) removing the front shell (54).

2. The method for forming the front shell (54) of the mobile communication device as claimed in claim 1, wherein the first female part (42) comprises a first inner cavity (44) and the second female part (52) comprises a second inner cavity (53) having a shape different from that of the first inner cavity (44), and the first male part (41) and the first female part (42) form a third cavity (45) and a fourth cavity (48) to receive the first and second films (43, 43′).
